(19) United States
(12) Patent Application Publication
(10) Pub. No.: US 2005/0021965 A1
(43) Pub. Date: Jan. 27, 2005

(54) In a networked environment, providing characterized on-line identities and matching credentials to individuals based on their profession, education, interests or experiences for use by independent third parties to provide tailored products and services

(76) Inventor: Richard J. Van Horn, Montclair, NJ (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/458,079

(22) Filed: Jun. 10, 2003

Related U.S. Application Data
(60) Provisional application No. 60/387,313, filed on Jun. 10, 2002.

(51) Int. Cl. H04L 9/00

(52) U.S. Cl. 713/176

(57) ABSTRACT

A system creates and distributes electronic credentials to members of Special Interest Groups (SIGs). The credentials may be relied upon by independent on-line third party merchants having no prior relationship to the individuals issued the credentials, to identify and characterize those individuals based on membership in the SIG that issued those credentials. Merchants with which the SIG members repeatedly interact can use the credentials to identify and characterize the participating SIG members based on prior interactions as well as group membership. Using cryptography, the merchant party can identify and authenticate the individual presenting the credential as the original owner of the credential, and affirm that the presenting individual is affiliated with the SIG. Based on the individual's authenticated affiliation with the SIG, the merchant can accurately and reliably infer characteristics of the individual and tailor products and services accordingly.

### CROSS REFERENCE TO RELATED APPLICATIONS

This application claims priority under 35 USC §119(e) to provisional application Ser. No. 60/387,313, entitled “IN A NETWORKED ENVIRONMENT, PROVIDING “CHARACTERIZED ONLINE IDENTITIES” AND MATCHING CREDENTIALS TO INDIVIDUALS BASED ON THEIR PROFESSION, EDUCATION, INTERESTS OR EXPERIENCES FOR USE BY 3RD TO PROVIDE TAILORED PRODUCTS AND SERVICES”, and filed Jun. 10, 2002.

### STATEMENT REGARDING FEDERALLY SPONSORED RESEARCH OR DEVELOPMENT

N/A

### BACKGROUND OF THE INVENTION

The present invention relates generally to electronic communications, and more specifically to a system and method for authenticating the identity and group membership of network users for the purpose of offering targeted services and/or products in an electronic network environment.

When the term “identity” is used, it is generally assumed or implied that the “identity” being discussed is an individual's unique legal identity within a physical geography or recognized nation-state. Legal identities may consist of an individual's legal name and an identifier provided to them by their federal or state government. Such a legal identity may be used throughout the individual's life to represent that individual to other individuals, his/her government, commercial enterprises, etc.

Establishing a legal identity in the physical world is a well-defined process: individuals are typically provided their legal names at birth, which are recorded on their state-sanctioned birth certificates. A separate but related process is performed to obtain a state-sponsored identifier, such as a Social Security Number (SSN), that is associated to that legal name. The individual's legal name and state sponsored identifier are used throughout that individual's lifetime to identify him or her in the physical world. These identifiers enable the individual to obtain certain types of credentials, such as a passport or drivers license.

Consistent legal identities are important in the physical world to support attributable transactions where product or service providers identify the consumer of their products/services during the transaction. A credit transactions, in which a provider extends credit to a consumer, is an example of an attributable transaction. To determine credit worthiness, and to ensure that legal remedies are available in the event of default, an identification process is performed by the provider to validate the consumer's legal name, in order to assess their ability to pay at a future date. In contrast, anonymous transactions, in which vendors need not identify the consumer to safely complete the transaction, include cash, money order or bearer transactions. Because the vendor is receiving cash, the vendor does not face any risk of loss or default. As a result, they do not need to identify the consumer at the point of sale for possible legal action later.

Legal identity and consistency of that identity across service providers is critical to prevent fraud. Transactions with any degree of financial risk, or those that require an individual to otherwise be held legally accountable, require that the product/service provider authenticate the identity of the consumer. To accomplish this, the product/service provider requires proof of the consumer's legally binding name, which may be provided through state sanctioned and sponsored credentials such as those mentioned above.

For example, an individual browsing the aisles of a liquor store may select various items and go to the checkout counter. If there is any question whether that individual is legally allowed to purchase alcohol, they are asked to confirm their legal identity and age by showing their drivers license. When opening a bank account, potential consumers may be asked to provide identification as part of “know your consumer” regulations designed to prevent illicit money laundering. These sorts of steps are performed by many service providers relying on this type of state issued credentials. On an international basis, passports are distributed to a country's citizens to associate that individual with a country and indicate the individual's citizenship in that country. Other countries may then rely on such credentials to determine the individual's right to enter such countries.

In all these examples, and in the majority of situations, states and countries issue credentials that reliably identify individuals in their physical domain or geography by their legal name. For example, to obtain a driver's license, many states require presentation of an individual's original birth certificate and social security card. Many states consider these documents the primary identification mechanisms for most United States citizens. The significance of asking for original documents is critical, because the states assume that the individual physically presenting those originals is indeed the individual named in those documents. Thus, the possession of such original documents reliably authenticates the legal identity of the individual.

By including a picture of the individual in an issued credential, that credential can further be conveniently be linked to a physical individual, and accordingly that individual can be reliably linked to the legal name on the credential. Third parties, independent of both the individual holding the credential and the issuer of the credential, can rely on these types of credentials to confirm the legal identity of an individual for a variety of services. Because states perform some due diligence when they issue such credentials, third parties relying on such credentials can be confident of the legal name of the individual presenting the credential.

Legal Identity & the Internet

With its explosive growth over the past 5 years, the Internet has become a significant extension to traditional commerce. Service providers and consumers come together on-line for delivery of a variety of services. However, identifying and authenticating on-line consumers has been difficult, since there is no equivalent of a credential such as a driver's license on the Internet. Without the ability to confirm the legal identity of a consumer via a credential such as a driver's license, birth certificate or their on-line equivalent, service providers on the Internet are faced with the alternatives of either not providing certain services, or accepting a higher degree of fraud resulting from identity theft.

To mitigate such risks and to exploit the opportunities presented by on-line commerce, (E-Commerce), a variety of existing on-line credentials are being used to identify and authenticate consumers. These existing credentials have varying degrees of reliability and have had varying degrees of success. Existing solutions used to legally identify online consumers have require product/service providers (on-line merchants) to:
1) Distribute their own credentials to existing consumers,
2) Outsource credit risk by relying on 3rd party payment mechanisms, and/or
3) Ignore legal identities and issue new identities to their consumers.
   Distributing Proprietary Credentials To Existing Consumers

Many product/service providers with established consumer bases, including consumers previously identified via driver's licenses or their equivalent, are issuing those consumers proprietary online credentials. These credentials are proprietary because the consumer can use them to identify & authenticate themselves to the credential issuer, in this case, typically a single product/service provider. By issuing their own online credentials, product/service providers can extend services previously offered exclusively in the physical world to their existing consumers via the Internet. With these online credentials, consumers can interact with the product/service provider over the Internet, and the provider can have a high degree of confidence regarding the identity of the consumer. However, those credentials are typically valid only between the two parties: the consumer and the product/service provider that issued the credential. Other parties cannot easily rely on this kind of online credential because:
1) Product/service providers do not typically share their client lists,
2) The predominant technologies used for online credentials cannot be relied upon by other parties to identify a consumer, and
3) Many product/service providers are not in the identification business where they derive revenue from charging others for the right to rely on their online credentials. In contrast, in the physical world, product/service providers rely on the state to perform that function and when forced do perform the function on the Internet; they typically perform it exclusively for themselves.

To summarize, proprietary online credentials issued by a product/service provider to its existing consumers:
1) Extend the provider's services to the Internet for their existing consumers,
2) Associate the consumer's legal identity with an online identity, as previously determined by the provider,
3) Do not support establishing new online consumers with no previous physical relationship with the provider, and
4) Do not support other product/service providers relying on those same credentials.
   Outsourcing Credit Risk By Relying On 3^{rd} Party Payment Mechanisms

Product/service providers that do not have a large, existing proprietary consumer base, or that wish to accept online payments from many existing and new consumers, often rely on 3^{rd} party payment systems such as VISA or MasterCard. Credit cards represent a popular 3^{rd} party payment system for handling transactions in the physical world that are being used for the same purpose in the online world. However, in the physical world, this approach relies on the possession of a physical credit card to indicate that the card belongs to a specific individual. Such physical cards are delivered to their owners in a relatively secure manner: through the U.S. Postal Service or other reliable physical deliver service, to an address of record that can be verified via credit bureaus, etc. Also, in the physical world, the process of paying for services via a credit card requires the consumer to physically present the card. The product/service provider, knowing the card was delivered in a physical secure manner, relies on the fact that the individual possessing the card was indeed the owner. Additional measures such as reviewing the signature against the signature on the credit card receipt, checking a lost card list, etc. have increased the security of using credit cards in the physical world.

In the on-line world, however, physical possession of a card is not a reliable security control. In an on-line transaction, all a consumer needs to execute that transaction is the credit card number, expiration date and name on the card. The physical card and a verifiable signature are not required. Credit card numbers, names and expiration dates are easily obtained by anyone that has seen or processed the card. As a result, fraud committed with compromised credit card information is significantly higher online than in the physical world. Providers that rely on credit cards for online transactions must pay higher fees to offset those higher fraud rates.

While the risk of fraud on-line has proven to be significantly higher than for equivalent transactions performed in a physical store, credit cards still provide enough security to support a wide range of on-line transactions. While an imperfect solution, credit cards are the primary payment mechanism on the Internet, allowing previously unknown consumers to visit and perform transactions with on-line product/service providers. Credit cards are an example of 3^{rd} party payment systems that can be used to recognize the legal identity for a required payment, assert credit worthiness, and provide a payment mechanism for the product/service provider. However, using credit cards in this way focuses exclusively on the payment aspect of a transaction, since credit cards are typically used only at the point of payment. As a result, other parts of the interaction between the consumer and the on-line product/service provider are ignored. Accordingly, credit cards cannot be used to manage the on-line identity of a consumer prior to the point of actually purchasing the product or service.

To summarize, credit cards focus on a specific step related to e-commerce transaction needs. Accordingly, credit cards in an on-line context:
1) Allow product/service providers to sell products to previously known or unknown consumers with a reasonable expectation of being paid,
2) Do not identify a consumer in any way prior to payment, for marketing purposes, consumer relationship management, etc.
   Creating New On-line Identities for New Consumers

Several existing product/service providers that desire on-line identities for their consumers are taking the approach of issuing independent on-line identities without verifying the individual's legal identity or associating the two identities to each other. These product/service providers do NOT require legally identifying information when dealing with their consumers. Any identity will suffice to meet their needs, which are primarily to identify an individual online in a recurring/repeatable fashion in order to provide that individual access to the same online services over time. This approach ignores any previous relationship with the individual, but provides easy access to low risk services, an identity to associate with repeated interactions/services, and an opportunity to aggregate user information.

To summarize, current approaches for issuing new on-line credentials that ignore legal identity:
1) Allow the consumer to create a new online identity based on any criteria they choose,
2) Allow product/service providers to establish on-line identities at the point of creation for their future use,
3) Do not support other product/service providers relying on those same credentials, and
4) Do not support payments by the consumer to the product/service provider.
   Conclusions Regarding Existing Online Credentials

Legal identities are necessary for the majority of interactions in the physical world. They allow product/service providers to identify and recognize consumers for a variety of interactions including credit transactions, marketing promotions, government services, and others. However, the technologies issued today for legal on-line identities provide fragmented identification services, rather than a complete end-to-end identification process, as is provided in the physical world. In particular, existing on-line interactions provide no basis for characterizing individuals, for example based on physical traits, appearance, age, dress, as well as prior purchasing history, zip code, country, etc. In addition, current technologies for online identities provide only fragments of the complete identification process:
1) Two party credentials are typically issued based on a known legal identity and support existing consumers with a prior relationship with the organization that issued the credential,
2) Credit cards identify an individual by legal identity at the point of payment,
3) New credentials issued without regard for legal identity allow the creation of pseudo identities without any significant context, and that cannot be shared with 3^{rd} parties.
   Existing Uses of Digital Certificates

The X.509 Digital Certificate specification is approximately 20 years old and certificates are slowly emerging as an authentication mechanism on the Internet. Their usage has been focused on using 3rd party authentication for Credit Agencies issuing credentials to consumers that include their legal identity for 3rd parties to rely on. These credentials follow the model of legal identities in a physical geography or recognized nation state. Additionally, employers have issued credentials to their employees that include an identity recognized by the employer. Such credentials are relied upon by the employer and partners of the employer. These credentials follow the model of unique identities and responsibilities in a corporate environment.

In an example of an existing system for providing online identities, U.S. Pat. No. 6,263,447 describes creating online identities that reflect legal identities in the physical world, and which can be relied upon by 3rd parties to prevent financial fraud or identity theft of an individual's legal identity.

Accordingly, for the reasons stated above and others, existing approaches have significant shortcomings, and fail to address many needs of product/service providers with regard to convenient, voluntary and authenticated targeting of products and/or services in an on-line context based on an individual's interests, education or other characteristics.

### BRIEF SUMMARY OF THE INVENTION

In accordance with the present invention, a method and system are disclosed for creating and distributing electronic credentials to members of Special Interest Groups (SIGs). As discussed herein, membership in a SIG may reflect the Profession, Education, Interests or Experiences (PEIE) of the individual member. The disclosed credentials issued by the SIG may be relied upon by independent third parties, such as on-line merchants having no prior relationship to the individuals issued the credentials, in order to identify and characterize those individuals in the context of electronic commerce. On-line merchants with which the SIG members repeatedly interact can use the credentials to identify and characterize the participating SIG members based on prior interactions as well as on group membership itself. Using cryptographic techniques, a merchant can identify and authenticate the individual presenting the credential as the original owner of the credential, and affirm that the presenting individual is affiliated with the SIG. Based on the individual's authenticated affiliation with the SIG, the merchant can accurately and reliably infer relevant characteristics of the individual, and tailor products and services accordingly. After an individual establishes an ongoing relationship with a merchant, the disclosed credentials can be used to conveniently identify and authenticate the consumer, enabling the merchant to offer or present products and/or services based on interactions within that ongoing relationship, as well as on the SIG membership.

The disclosed system and method advantageously provides individuals within a domain of users defined by common characteristics or interests, a unique identity embodied within a credential that can be relied upon by independent 3rd parties without any prior relationship with the owner of the credential. Because the credential is reliably issued by a specific organization, characteristics about the individual possessing the credential can be reliably determined. Because the credential travels with the individual as they travel the Internet, credentials can be relied upon by multiple 3rd parties.

As described herein, an online identity issued to an individual based on their profession, education, interests or experiences is referred to as a “characterized on-line identity”. A credential that associates a physical individual to their characterized on-line identity is referred to as a “characterized on-line credential”. The disclosed characterized on-line credentials are created based on an individual's desire to characterize themselves as a member of a special interest group, and to publicize their membership to 3rd parties. SIGs have the option not to create credentials for members that do not wish to advertise their membership to 3rd parties. SIG members that want a characterized on-line credential have the options of using either their legal name, or a pseudonym unique within the SIG. The disclosed approach protects member's privacy by allowing them to 1) determine whether they want a characterized online identity to advertise their membership in the SIG, and 2) choose the on-line identity they want associated with the SIG on their behalf. By enabling provision of an on-line identity independent from legal identity of an individual, the disclosed method and system enable an individual with a characterized on-line credential to browse the World Wide Web and receive offers of products and services based on demographics associated with that credential, while not revealing their legal identity or other personal information. Alternatively, the disclosed characterized on-line credentials can be used to identify an individual by their legal identity. Because the on-line identity embodied in the credential is unique (within the associated SIG), and statically assigned to a single individual, vendors with a previous relationship to that individual can also use that credential to alias a pseudonym used in the credential to the individual's separately provided actual legal identity.

As disclosed herein, the disclosed system and method operates to conveniently create a unique characterized online identity and matching characterized online credential for individuals that prove they are members of a SIG based on their Profession, Education, Interests or Experiences (PEIE). An individual may advantageously have multiple characterized online identities and characterized online credentials that may or may not be related to each other or the individual's legal identity. The disclosed characterized online identity is unique within the SIG that issues the associated characterized online credential, and is ensured by the SIG to only be issued to a single individual. The disclosed characterized online identity can be distinct from an individual's legal identity, and allows its owner to browse the Web and receive tailored product/service offerings based on their membership in a larger group and the aggregated demographics of the organization's members. The provision of the characterized on-line identity separate from legal identity by the disclosed system and method allows an individual to maintain privacy with respect to their legal identity when browsing the Web. Merchants can rely on the disclosed characterized on-line credentials to uniquely identify, authenticate and characterize individuals within a SIG, without a prior relationship to the individual. Merchants that wish to characterize individuals for marketing, training or other purposes can rely on the disclosed characterized on-line credentials to uniquely identify an individual as part of a SIG without prior contact with the individual, or the need for additional identifying procedures. By authenticated association with a SIG, characteristics about an individual can be reliably determined by merchants when the individual presents their characterized on-line credential. For new visitors, characterized online credentials can be used to tailor products and services based on characteristics inferred by their membership in the SIG. SIGs may collect demographics of their members and explicitly advertise the aggregated information to encourage merchants to participate in these programs. For repeat visitors, the unique identity within the SIG as provided by the disclosed characterized on-line credential can be used to associate specific interests, choices, etc. derived from previous visits and/or transactions with the merchant. For individuals that offer (or have previously offered) their legal identity to the merchant, the disclosed characterized on-line credentials can be used by the merchant to associate the individual with their legal identity. In effect, the disclosed characterized on-line credentials can be an alias to a merchant that already knows an individual's legal name.

### BRIEF DESCRIPTION OF THE SEVERAL VIEWS OF THE DRAWINGS

The invention will be more fully understood by reference to the following detailed description of the invention in conjunction with the drawings, of which:

FIG. 1 is a flow chart illustrating steps performed in an illustrative embodiment to obtain a characterized online credential;

FIG. 2 is a flow chart illustrating steps performed in an illustrative embodiment to use a characterized online credential;

FIG. 3 shows devices and software components in an illustrative embodiment including a second party SIG computer system and an end user system;

FIG. 4 shows devices and software components in an illustrative embodiment including a second party SIG computer system and a third party merchant computer system; and

FIG. 5 shows devices and software components in an illustrative embodiment including a third party merchant computer system and an end user system.

### DETAILED DESCRIPTION OF THE INVENTION

The disclosures of provisional application Ser. No. 60/387,313, entitled “IN A NETWORKED ENVIRONMENT, PROVIDING “CHARACTERIZED ONLINE IDENTITIES” AND MATCHING CREDENTIALS TO INDIVIDUALS BASED ON THEIR PROFESSION, EDUCATION, INTERESTS OR EXPERIENCES FOR USE BY 3RD TO PROVIDE TAILORED PRODUCTS AND SERVICES”, are hereby incorporated by reference herein.

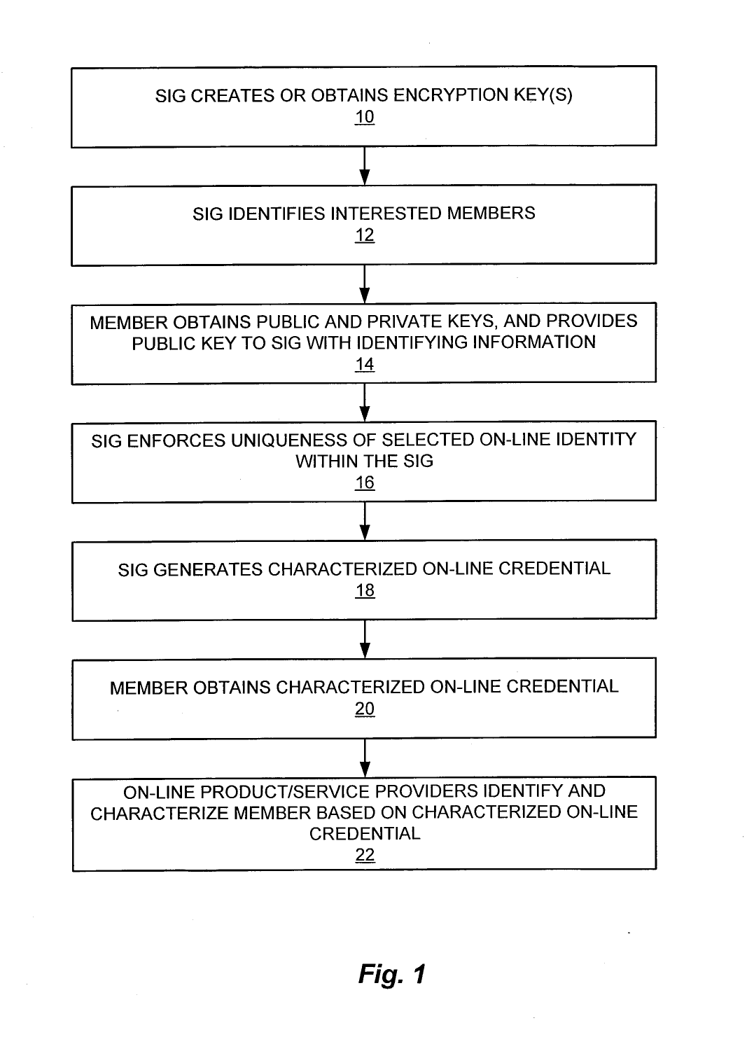

In accordance with the present invention, a system and method for providing characterized online identities and matching credentials is disclosed. As shown in FIG. 1, in an illustrative embodiment, a Special Interest Group (SIG) established based on Profession, Education, Interests or Experiences (PEIE), creates a Certificate Authority using an X.509 Certificate to represent itself at step 10. At step 12 of FIG. 1, the SIG reliably identifies at least one member interested in obtaining characterized online identities and matching credentials. Step 12 may, for example, be performed using established off-line procedures determined adequate to identify existing members or to interrogate potential members that may be located anywhere in the world, or using new procedures designed to support either new or existing member sign up through an on-line, Web based interface including a number of Web pages accessible to Web browsers and provided by a Web server controlled by the SIG.

Upon successfully being identified as a member of a SIG, the individual obtains a public and private key pair using asymmetric cryptography at step 14. Further at step 14 of FIG. 1, the individual presents their public key to the SIG with identifying information about himself/herself, including either the individual's actual legal identity and/or an on-line pseudonym. The SIG may require that the individual's on-line identity coincide with their legal identity, as previously determined by policies of the SIG.

The SIG then determines at step 16 if the requested characterized online identity is unique within its domain of members. If it is not unique, the SIG may ask the individual to submit another identity or create a unique identity on behalf of the individual. For example, if the SIG represents a single group of individuals, the fact that the credentials were created by that SIG represents that the individual identified in the credential is a member of that special interest group. If the SIG represents more than one group of individuals, or wishes to further differentiate its members, the SIG can create categories within itself (for example, year of graduation, years a member, etc.) and include indication of those categories in the resulting characterized online credential.

At step 18, the SIG combines the individual's public key and identifying information to create a characterized online credential, for example in the form of an X.509 Digital Certificate. The characterized online credential created at step 18 is digitally signed by the private key of the SIG's certificate authority. The individual then retrieves their characterized online credential from the SIG's certificate authority at step 20.

Following step 20, the individual has a characterized online credential, for example in the form of an X.509 Digital Certificate, that consists of a public key combined with a unique identity, that was issued by a SIG associated with Profession, Education, Interests or Experiences (PEIE), and that was digitally signed by that SIG's Certificate Authority (CA). On-line service providers wishing to identify and characterize individuals based on the disclosed characterized online credentials must recognize that the SIGs CA certificate represents that SIG electronically, and implicitly or explicitly accept the procedures the SIG performs to issue credentials.

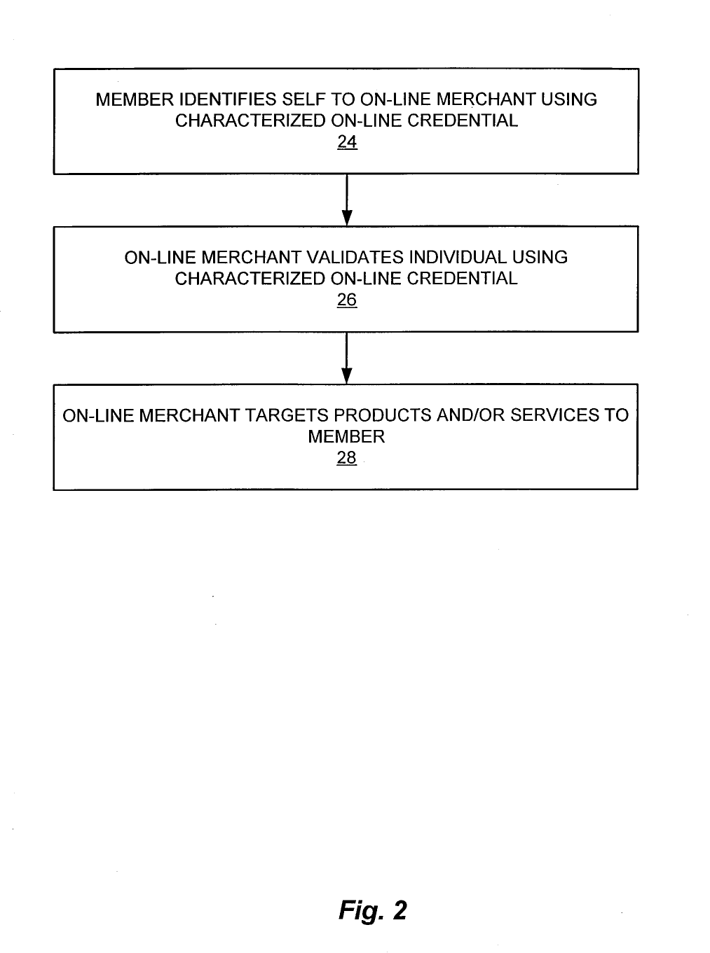

As shown in FIG. 2 at step 24, when visiting 3^{rd} party online service providers, the individual identifies and authenticates himself/herself using public key cryptography, such as Secure Sockets Layer (SSL, see U.S. Pat. No. 5,657,390), using his own private key and the characterized online credential issued in the form of an X.509 certificate from the SIG.

Using public key cryptography, at step 26 the 3rd party online merchant validates that the individual possesses an X.509 public certificate issued by the SIG's CA, and the private key associated with the public key contained in the certificate. By determining the characterized online credential was created by the SIG's CA, the 3rd party can be assured the individual is a member of that special interest group. Through using public key cryptography, the characterized online credentials are protected from modification and reliably associated with the issuing SIG CA.

If an individual has multiple characterized online identities, for example one for each special interest group to which they belong, they can select which credential to use to identify themselves at each particular 3rd party merchant they may visit. After identifying, authenticating and characterizing an individual through their characterized online credential at step 26, a merchant can provide specific targeted products and/or services based on that characterization and the demographics of the larger group at step 28. If the individual possessing the characterized online credential has a previous relationship with the 3rd party based on their legal identity, or the individual offers their legal identity as part of a transaction, the 3rd party can use the characterized online credential to provide access to any information associated with that legal identity. When using a characterized online credential to access personal information associated with an individual's legal identity, service providers may be required to check that the credential is still valid and belongs to the proper individual.

The disclosed process for identifying and authenticating the holder of a credential uses asymmetric cryptography. Accordingly, the individual has a unique private key in their possession that only they can access, and the SIG organization digitally signs the individual's public key that matches the individual's private key. The individual's private key is used to encrypt a message (often called a “proof of possession” indicating that the individual identified in the credential possesses the private key matching the public key in the credential) which is sent to the 3rd party merchant desiring to identify the individual. The individual also provides their public key, which was encrypted (in this case digitally signed) using the SIG organization's private key. Using 3 components 1) the proof of possession message encrypted using the individual's private encryption key, 2) the individuals public encryption key contained in the credential that was signed by the 2nd party, and 3) the publicly available key corresponding to the SIG organizations private encryption key that was used to sign the credential, the 3rd party merchant can uniquely identify the individual holding the private key, authenticate that they are the same individual that initially obtained the private key corresponding to the public key in the credential, and reliably determine that they are a member of the SIG organization that issued the credential.

Now again with reference to FIGS. 1 and 2, steps performed in an illustrative embodiment of the disclosed system are described in further detail. Initially, a SIG organization creates or obtains an encryption key (such as a private key) representing their organization, as in step 10 of FIG. 1. The encryption key of the SIG organization can then is used to encrypt other data to create credentials with a unique identity for each individual that is a member of the SIG organization. Data that may be encrypted with the encryption key of the SIG organization can include, but is not limited to: other encryption keys, and pseudonyms for individual members of the SIG organization. In one embodiment, the SIG organization also establishes an automated service, referred to as the “credential status software”, to respond to requests regarding a credential's current status.

As in step 12 of FIG. 1, individual members of the SIG organization are solicited to request a credential via a Web site or other online service. Those members may be solicited in a number of ways including but not limited to the following:
a. Upon visiting the organization's Web site, the member is asked to submit information electronically that the organization uses to confirm the individual is a member. This information could, for example, include a membership number, an existing User ID and password.
b. The SIG organization sends an email to each member asking them to register for a credential. That email includes unique information specific to the member, such as a unique URL. Using that unique information, the member is brought to a Web site that automatically identifies them as a member via information in the URL.

After identifying and authenticating the individual is a member of the organization, as part of the process to create an individual's unique credential at steps 14 and 16, the organization requests information from the member that can include, but is not limited to, the following:
a. Demographic information
b. The individual's preferred online name, which may be the individual's legal name or a pseudonym.
c. A unique encryption key, such as the individual's public key.
d. Details about the technical platform or software they are using.

Further in connection with steps 14 and 16 of FIG. 1, the individual member submits the requested information to the SIG organization. The organization confirms that the online name chosen by the individual to be their unique online identity, is unique among all other members of the SIG organization. If the requested name is not unique, the individual is asked to submit an alternative. If the names submitted continue to be duplicates, the organization may offer alternatives for the individual to select.

As in step 18 of FIG. 1, using the SIG organization's encryption key, the SIG organization then creates a credential for the member including, but not limited to, the following information:
a. A name or other information that identifies the organization that created the credential.
b. The preferred name of the member.
c. Lifespan of the credential.
d. The encryption key (public key) provided by the member.

The SIG organization records the details of the credential along with the other information already maintained about the member in a database. The organization distributes the credential to the owner, as in step 20 of FIG. 1.

The process of generating a characterized on-line credential for an individual can be repeated by that individual with several organizations, providing a single individual many online credentials from several SIG organizations. Merchants having no prior relationship with the individual that wish to identify visitors to their Web site or other online services as members of a particular SIG organization, integrate the organization's public key into their Web site. As part of such integration, the merchant creates personalization software to provide personalized Web content to members of the SIG organization.

As in step 24 of FIG. 2, members of the SIG organization surf the Web with their characterized on-line credential, and visit participating 3rd party merchant organizations' Web sites. On their Web site, the 3rd party merchants may advertise special discounts or other services to members of particular organizations. Accordingly, for example, while visiting such a Web site, an individual may choose to view or take advantage of such a special discount. As a result, a series of steps may occur with step 26 of FIG. 2 as follows for one embodiment of the disclosed system:
a. The Web server of the merchant requests the individual to identify themselves.
b. The individual's Web browser or other software may operate as follows:
   i. If one credential is stored in the browser of the individual, the browser software submits their credential to the Web site.
   ii. If more than one credential is stored in the individual's browser, the browser software allows the individual to select which credential to use, and the browser submits the credential to the Web server.

The 3^{rd} party merchant's Web site then cryptographically processes the credential using the SIG organization's publicly available key. If the credential was encrypted with the organization's encryption key, this step determines whether the individual is a member of the organization that owns that encryption key. In addition, the merchant's Web site determines whether the individual's credential has not expired. The merchant's personalization software then operates to perform the following actions as in step 28 of FIG. 1:
a. Determine if the identity in the credential belongs to an existing client.
b. If not, present a Web page that describes the discounts and other member-only services specific to the SIG that issued the credential. The personalization software may have many personalized Web pages, one or more of such Web pages dedicated to each organization it recognizes.
c. The web site records information about the individual's visit and associates it with the unique identity in the credential.

The member may end their visit but visit again several days later. He/she may again choose to view the offer for special discounts. Their Web browser or other software submits their credential to the Web site. The Web site retrieves the credential and using the SIG organization's public key, verifies that the individual is a member. The personalization software then determines if the individual visited previously, and:
a. In the event that the individual has visited previously (identified by their unique identity in the credential), the Personalization software provides Web pages personalized based on the fact the individual belongs to a particular organization and has visited previously.
b. The Web site records information about the individual's visit and associates it to the unique identity in the credential.

Further for purposes of explanation, during the current visit, the individual decides to purchase a product. To complete the transaction, the individual submits personal information including but not limited to their true legal name, address, zip code, phone #, Social Security Number, Credit Card Number, etc. As a result of the transaction, the following may occur:
a. The merchant completes the transaction and stores this client information in a database.
b. That client information is then associated with:
   i. The information collected from previous visits.
   ii. The unique identity in the credential used to initially identify them as a member of the organization that issued it.

The individual then leaves the Web site and returns a few days later. The individual selects the special discount or, because they actually purchased a product during their last visit, selects the option to logon as an existing client. Their Web browser or other software submits their credential to the Web site. The Web site then retrieves the credential and, using the organization's encryption key, verifies the individual is a member of the SIG and that the credential has not expired. The Web site determines also determines that the individual is also a prior customer. Because the identity in the credential is unique and belongs to a single individual, the 3rd party merchant can look up the identity in their client database. After determining the individual is an existing client, the 3rd party merchant queries the credential status software maintained by the SIG organization to determine the status of the credential. If the credential status software responds that the credential is still active, the 3rd party merchant can permit access to the transactional and personal information associated with that credential from prior visits. If the credential is revoked for some reason, the merchant will deny access to all information and discounts.

FIGS. 1-2 are flowchart illustrations of methods, apparatus (systems) and computer program products according to the invention. It will be understood that each block of the flowchart illustrations, and combinations of blocks in the flowchart illustrations, can be implemented by computer program instructions. These computer program instructions may be loaded onto a computer or other programmable data processing apparatus to produce a machine, such that the instructions which execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps prformed on the computer or other programmable apparatus to produce a computer implemented process such that the instructions which execute on the computer or other programmable apparatus provide steps for implementing the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or combinations of special purpose hardware and computer instructions.

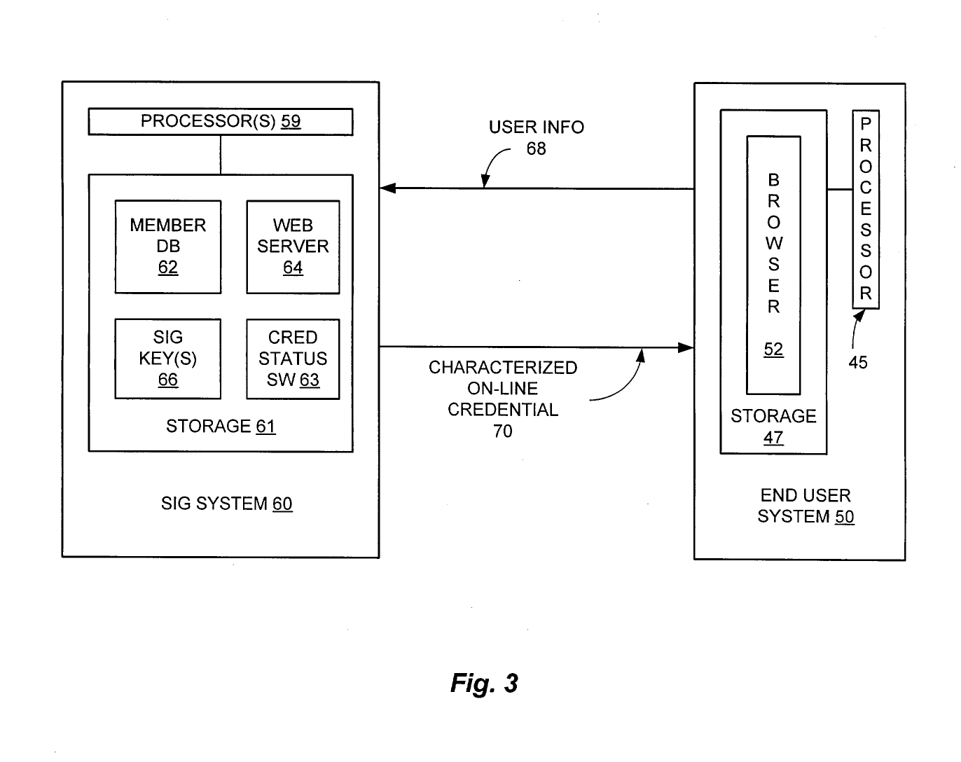

FIG. 3 shows an illustrative embodiment of the disclosed system to describe an example of an: end user registration to receive a credential. As shown in FIG. 3, an end user computer system 50 includes at least one processor 45 and program storage memory 47, wherein said program and/or data storage 47 includes Web browser software 52 or some other appropriate interface. The SIG computer system 60 is shown including at least one processor 59, program and/or data storage 61, a Web server or other interface 64, member database 62 storing member names and associated information, and one or more encryption and/or decryption keys 66, such as public and corresponding private keys. The end user system 50 and SIG system 59 are, for example, interconnected by way of a communication network such as, for example, the Internet.

During operation of the system shown in FIG. 3, the SIG organization system 59 creates the at least one encryption key that represents the organization within the keys 66. Using the browser or other interface 52, the user individual identifies & authenticates themselves online as a member of the SIG for the SIG system 59. The member also chooses a unique alias to be known as in the future and submits it to the SIG system 60 as part of one or more messages including identifying information, encryption key (such as the members personal public key), and the preferred alias for that member. Software or other processes operating in the SIG system 59 confirms that the individual is a member, and that their chosen alias is unique. Software executing in the SIG system 60 also creates a credential 70 that is at least in part cryptographically sealed using one of the SIG keys 66, and that includes the individual's chosen alias. In one embodiment, the characterized on-line credential includes the following information:
Member Name or Pseudonym
Name of Issuing SIG Organization
Validity Period (from xx/yy/zz to xx/yy/zz)
The Credential's Unique Serial #
Encryption Material, including any one of several types of conventional encryption material that can be used to ensure the credential is accurate and was created by the issuing SIG organization.

Software within the SIG system 60 then adds the chosen alias for the member contained in the credential to the other information about the member in the member database 62. The SIG system distributes the cryptographically sealed credential that includes individual's chosen alias, as well as information regarding and/or describing or identifying the issuing SIG.

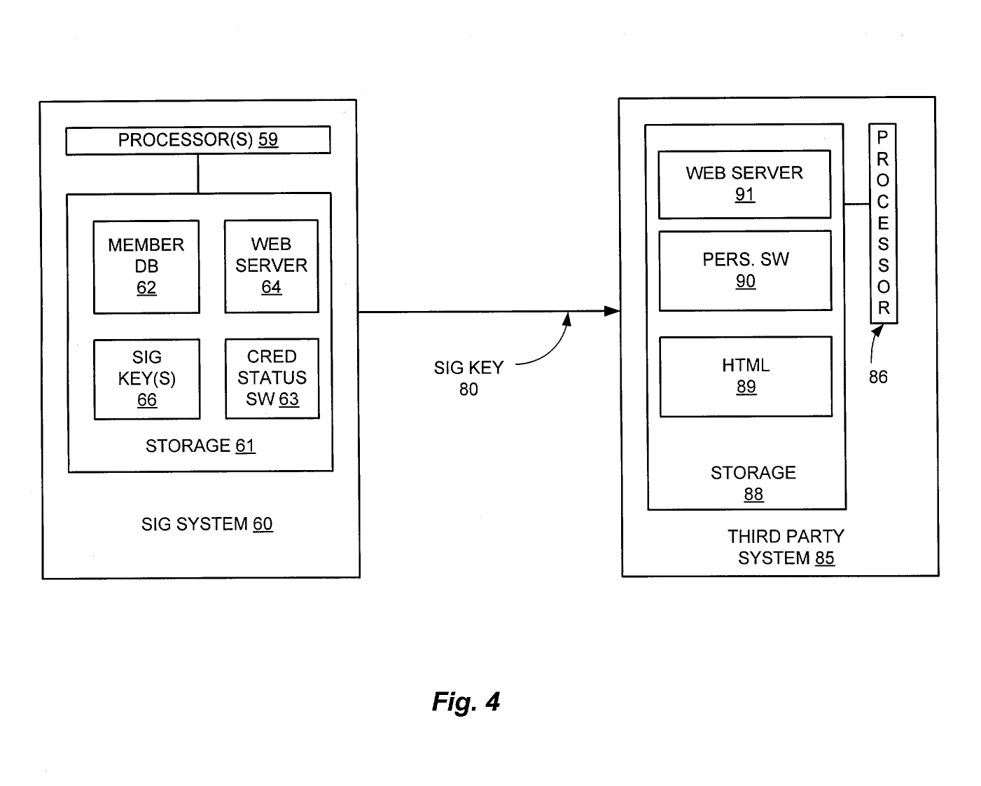

FIG. 4 shows an illustrative embodiment of the disclosed system to describe an example of a third party merchant integrating a SIG key, such as a public key of the SIG. As shown in FIG. 4, a third party merchant system 85 includes at least one processor 86, as well as program and/or data storage 88. The program and/or data storage 88 is shown including customized Web pages 89, as well as personalization software 90 that includes logic that presents the customized Web pages upon demand though a Web server or other online interface 91. The third party merchant system 85 is communicably connected with the SIG system 60 through a communications network, such as the Internet.

During operation of the embodiment illustrated in FIG. 4, the third party merchant agrees to provide specialized services to members of the SIG associated with the SIG system 60. As a result, the SIG system 60 provides a copy of an encryption key 80 representing the SIG, such as the public key for the SIG. The third party system 85 integrates the SIG's encryption key 80 into their Web server or other online interface 91. The third party merchant may further create one or more Web pages 89 specifically for members of the SIG. The personalization software 90 presents the customized Web pages 89 to member's of the SIG after presenting their cryptographically sealed credential.

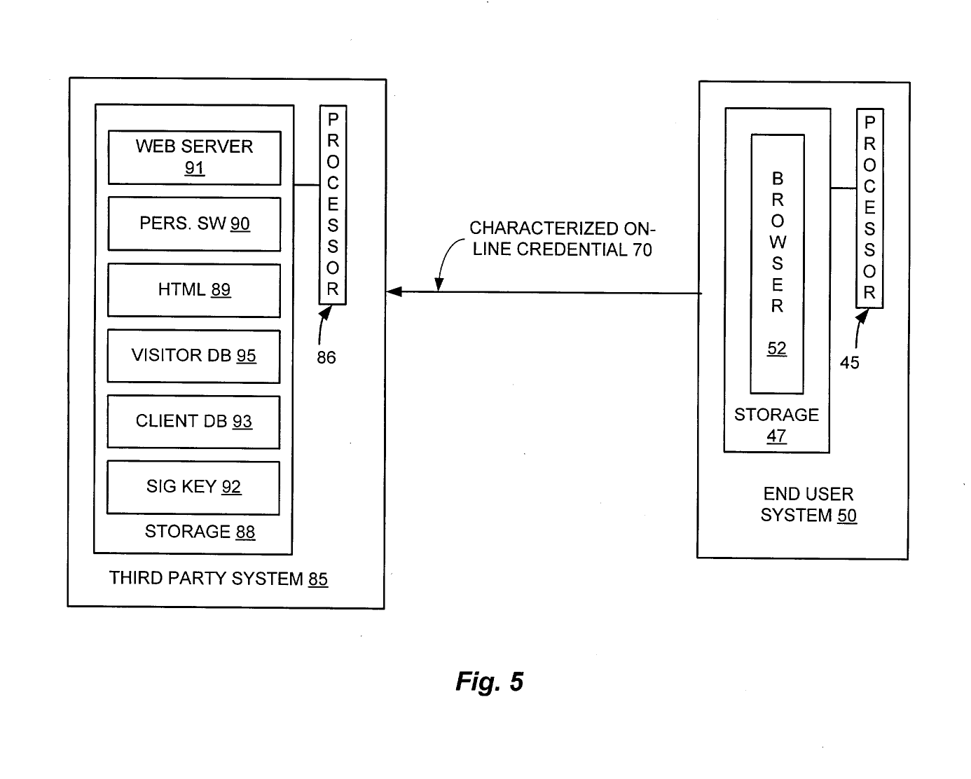

FIG. 5 components in an illustrative embodiment for the purpose of describing an example of how a third party merchant accepts credentials from SIG members during their initial visit to a Web site of the merchant. The end user system 50 and third party system 85 are connected by a communications network, such as, for example, the internet. During operation of the disclosed system, a member of a SIG visits a participating on-line merchant's Web site, as provided by the third party system 85. The visited Web site queries the Web browser or other interface 52 in the end user system 50 for a credential. Depending on the SIG's the third party recognizes, the browser 52 may allow the individual to select one of several acceptable characterized on-line credentials stored in the browser 52. The member individual submits their selected credential 70 using the browser 52 to the third party system 85. Using the SIG's encryption key 92, the third party system 85 confirms that the individual's credential was issued by the associated SIG. Based on the individual's membership in the SIG, using the personalization software 90, the third party system 85 presents the customized Web pages 89 associated with the SIG to the end user. Software in the third party system 85 further records the actions taken during the visit and associates any specific details to the identity in the provided credential in the visitor database 91.

In the event that a member of the SIG visits the Web site of the third party a second time, several steps are performed. The Web site provided by the third party system 85 queries the Web browser or other interface 52 for a credential. Again, depending on the SIG's the third party recognizes, the browser 52 may allow the member individual to select one of several acceptable credentials. The member individual submits their credential 70 to the third party system 85. Using the SIG's encryption key 92, the third party system 85 confirms the individual's credential was issued by the associated SIG. Using the visitor database 91, the third party system 85 determines the identity in the credential has visited previously. Using the personalization software 90, the third party system presents the customized Web pages 89 to that individual based on 1) the individual's membership in the SIG and/or 2) information obtained about the individual during any prior visits. The third party records the visit in the visitor database 91 and associates any specific details in association with the identity provided in the credential.

The third party system 85 is further operable to accept personal information. In the event that a member of a SIG visits the third party Web site provided through the third party system 85, the third party Web site queries the Web browser or other interface 52 for a credential. Again, depending on the SIG's the third party recognizes, the browser 52 may allow the individual to select one of the acceptable credentials. The individual submits their credential 70 to the third party system. Using the SIG's encryption key 92, the third party system 85 confirms the individual's credential was issued by the associated SIG. Using the visitor database 91, the third party system determines that the identity in the credential is associated with at least one previous visit to the Web site. Using the personalization software, the third party system 85 presents the customized Web pages 89 to that individual based on 1) the individual's membership in the SIG and/or 2) information obtained during any prior visits to the Web site. The individual chooses to purchase a product or service and may additionally submit personal information required by the third party system to complete that transaction, for example using the browser 52. The third party system 85 receives the provided personal information through the Web server 91, and associates the transaction and any associated personal information in the visitor and/or client databases 91 and 93, in association with the identity stored in the credential.

In the case where the third party system 85 operates to accept a credential for an existing client, the SIG member visits the third party's Web site provided through the third party system 85. The third party's Web site queries the Web browser or other interface 52 for a credential. As previously noted, depending on the SIG's the third party recognizes, the browser 52 may allow the individual to select one of several acceptable credentials. The individual then submits their credential 70 to the third party system 85. Using the SIG's encryption key 92, the third party system 85 confirms the individual's credential was issued by the associated SIG. Using the client database 93, the third party system 85 determines the identity in the credential is an existing client of the third party. The third party system 85 accesses the credential status software 63 in the SIG system 60 to determine if the credential is still valid. If the credential is still valid, the third party system provides access to the individual's personal information based on their prior visits and transactions and any special discounts offered to them based on their membership in the SIG. If the credential is invalid, the third party system 85 will deny access to all services and data.

The disclosed characterized on-line credentials are a powerful technical solution that 1) identifies an individual as a member of a SIG organization to a 3rd party merchant having no prior relationship with the individual using a pseudonym that protects the individual's privacy, and 2) authenticates or confirms the individual's identity in an on-line distributed environment using cryptographic techniques. The disclosed system may, for example, be embodied using credential creating software including software that identifies the individual to the SIG organization, receives their preferred name for the credential and other information, and issues a credential from the SIG organization to the individual. Moreover, credential status software may be used that provides information about the status of a particular credential. A Web browser, or other software, may be used to manage credentials and related activities for the end user individual including:
Submission of information as part of the credential creation process.
Storage of the credential.
Submission of the credential as part of the process to identify and authenticate the end user.
Allowing the user to select which credential to use for a given transaction, etc.

Web server or other software, may be used to request the individual's credential as part of the process of identifying the end user by the merchant. Personalization software including software configured and/or developed by a merchant may be used that, upon receiving the credential offered by a 1st party, operates to:
Determine if the credential was issued by a SIG organization or other party that the 3rd party merchant has a relationship with.
Determine whether the credential and has expired.
If the credential was issued by a SIG organization or other party that the 3rd party has a relationship with, determine which SIG organization or other party issued the credential, and provide one or more personalized Web page(s) based on that determination. The personalization of the Web pages presented will be based on the aggregated demographics of the SIG organization or other party and/or previous visits of the individual.
Allow individuals to purchase goods or services which may require the individual to further identify themselves (with specific personal details including but not limited to credit card number, address, name) in a manner required by the 3rd party merchant.
Associate a pseudonym in the credential to identity and transaction information submitted by the individual to the 3rd party merchant.
Upon subsequent visits, 1) interface with the credential status software to determine the status of a credential and ensure that it still belongs to the original owner, 2) alias the credential to the individual's real identity based on prior visits, and 3) provide one or more personalized Web pages based on the individual's membership in the SIG organization and/or their prior visits and personal information provided as part of such prior visits to the 3rd party merchant Web site.

### SEPARATE CREDENTIAL PROVIDER EMBODIMENT

While the above description refers to SIG organizations generating their own credentials for distribution to and use by their members, the present invention is not limited to such embodiments. In an alternative embodiment, a business entity independent of one or all SIGs creates a certificate authority in its own name or brand, and sells its services as a provider of characterized on-line credentials to one or more SIGs. The credential providing company creates credentials including the name of the credential providing company as the issuer, and further including the respective SIG's name as an attribute in the certificate, along with the individual's name or pseudonym.

In such an embodiment, third party merchants may contract with and pay the credential providing company to target marketing information to individuals with credentials, for example using electronic mail or some other appropriate communications medium. Instead of customizing their offerings based on the name of the issuer of the credential, which may, for example be the certificate authority provided by the credential providing company, third party merchants operate to customize their product and/or service offerings through reliance on the attribute in the certificate identifying the respective SIG. Accordingly, the characteristics associated with SIG membership can be determined through the certificate, even though the SIG did not directly issue the credential. Instead, a separate entity issued the credential to the SIG member on the SIG's behalf.

Advantages of the Disclosed System over Previous Solutions

This disclosed system provides many advantages over previous systems. For example, while they are pseudonyms, the identity in each credential issued to a SIG member individual by the SIG organization is unique to the individual and will always belong to that individual. While credentials may expire and be renewed, the pseudo-identity in the credential will always be issued to the same individual.

Because the characterized, on-line credentials are issued by a specific 2nd party SIG organization, aggregate demographics of that SIG's members can be assumed by 3rd party merchants that identify individual members by these credentials. Those demographics can include personal interests, disposable income, hobbies, etc. Moreover, because these credentials are cryptographically strong, 3rd party merchants can confidently confirm an individual is a member of a particular 2nd party SIG in an online distributed environment. And, because the identity in the credential is a pseudonym, the 1st party individual member can travel public networks in anonymity while being recognized as a member of the 2nd party SIG organization.

As a result of the individual's membership in the SIG, on-line merchants can provide specialized services to that individual member based on demographics of the overall organization. Because the pseudonym in the credential is unique within the SIG that issued the credential, individuals that visit merchants repeatedly, can be recognized as repeat visitors. As a result, the merchant can provide additional targeted Web pages based on the individual's prior visits to the merchant. This is in addition to the personalized Web pages provided based on the individual's membership in the SIG.

All the targeted marketing services enabled by the disclosed system can be provided without the 1st party providing any personal information. After completing a transaction and submitting personal information required by the merchant as part of that transaction, the individual and the merchant now have a 2 party relationship: each has a relationship with the other and can identify and authenticate the other without outside assistance. Because the credential possessed by the individual is unique, the merchant can use that same credential (used previously to identify the individual as a member of a particular SIG) to identify the individual directly as part of their new 2 party relationship. As a result, these credentials offer 2 different purposes:
1) They can identify an individual via a pseudonym to a 3rd party merchant and indicate membership in a particular 2nd party SIG organization that issued the credential.
2) After a direct relationship has been established between a 1st party individual and a 3rd party merchant, in which the 1st party individual offers personal information including their true identity—in effect creating a new 2 party relationship between the 1st and 3rd parties, the credential previously used to identify the 1st party individual to the 3rd party merchant can now be used to identify the 1st party directly to the 3rd party based on their 2 party relationship. Since the 3rd party is aware of the individual's pseudonym and their real identity, the 3rd party can use the pseudonym to recognize the true identity of the 1st party.

In contrast to previous identity solutions, the disclosed system:
1) Does NOT require the 1st party to share any personal information with any 3rd parties to receive discounts or other benefits. It is entirely up to the 1st party what personal information they disclose and to which 3rd parties.
2) Allows the 1st party individual to have 2 online identifies with each credential they possess: a) a true pseudonym for 3rd parties that have no prior relationship with the 1st party, and b) for trusted vendors, a pseudonym that maps to the individual's real identity.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using baseband signaling or broadband signaling techniques, including carrier wave signaling techniques, such as over computer or telephone networks via a modem. In addition, while the invention may be embodied in computer software, the functions necessary to implement the invention may alternatively be embodied in part or in whole using hardware components such as Application Specific Integrated Circuits or other hardware, or some combination of hardware components and software.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative data structures, one skilled in the art will recognize that the system may be embodied using a variety of specific data structures. Accordingly, the invention should not be viewed as limited except by the scope and spirit of the appended claims.

1. A method for facilitating on-line transactions, comprising:
obtaining, from a user, at least one on-line pseudo-identity to be associated with said user;
ensuring that said on-line pseudo-identity is unique within a special interest group in which said user is a member;
generating an electronic credential for said user, wherein said electronic credential includes said at least one on-line pseudo-identity to be associated with said user, and wherein said electronic credential further includes an identifier of said special interest group in which said user is a member;
electronically signing said electronic credential such that said electronic credential includes a digital signature;
making said electronic credential available to said user; and
making available to at least one on-line merchant at least one encryption key associated with said digital signature in said electronic credential.

2. The method of claim 1, wherein said at least one encryption key associated with said digital signature is a public key corresponding to a private key used to generate said digital signature.

3. The method of claim 1, wherein said making said electronic credential available to said user comprises making said electronic credential available to said user via at least one Web page interface accessible to said user through a Web browser software program.

4. The method of claim 1, wherein said making said encryption key associated with said digital signature available comprises transmitting said encryption key to said at least one on-line merchant via a communications network.

5. The method of claim 1, further comprising adding said on-line pseudo-identity to a database in association with a name of said user.

6. The method of claim 1, wherein said user is a member of said special interest group, and further comprising adding said on-line identity to a database in association with a membership number of said user.

7. The method of claim 1, further comprising:
receiving said electronic credential at said at least one on-line merchant;
determining, responsive to said at least one key associated with said digital signature in said electronic credential, whether said electronic credential has been tampered with; and
in the event that said electronic credential has not been tampered with, providing information regarding at least one commercial offering responsive to said identifier of said special interest group in said electronic credential.

8. The method of claim 7, wherein said providing said information regarding said at least one commercial offering comprises providing at least one Web page describing said commercial offering.

9. The method of claim 7, wherein said commercial offering is an offer to provide at least one service tailored to member characteristics associated with said special interest group.

10. The method of claim 9, wherein said at least one service is a discounted service available only to members of said special interest group.

11. The method of claim 8, wherein said commercial offering is an offer to provide a product at a discounted price.

12. The method of claim 7, further comprising determining whether said electronic credential is currently valid responsive to an indication of validity stored in a database associated with said special interest group.

13. The method of claim 7, wherein said on-line pseudo-identity is differs from said user's legal name.

14. The method of claim 1, wherein said step of generating said electronic credential for said user further comprises including a validity period in said electronic credential.

15. The method of claim 1, wherein said step of generating said electronic credential for said user further comprises including a public key of said user in said electronic credential.

16. The method of claim 1, further comprising:
wherein said step of generating said electronic credential further comprises determining whether said on-line identity is unique within said special interest group; and
in the event that said on-line identity is not unique within said special interest group, requesting a different on-line identity from said user.

17. The method claim 1, further comprising in the event that said user is associated with a previously defined on-line pseudo-identity, using said previously defined on-line pseudo-identity as said on-line pseudo identity to be associated with said user.

18. The method of claim 7, wherein said providing said information regarding said at least one commercial offering responsive to said identifier of said special interest group in said electronic credential is further responsive to stored information regarding at least one previous interaction between said at least one on-line merchant and said user, wherein said stored information regarding said at least one previous interaction between said at least one on-line merchant and said user is stored by said on-line merchant in association with said on-line pseudo-identity.

19. The method of claim 1, wherein said steps of generating said electronic credential, electronically signing said electronic credential, and making said electronic credential available to said user are performed on behalf of said special interest group by an independent business entity, and wherein said electronic credential further includes an indication of said independent business entity.

20. A system for facilitating on-line transactions, comprising:
at least one processor;
program and data storage for storing computer programs for execution on said at least one processor, and for storing related data;
computer program code stored in said program and data storage, said computer program code operable to
obtain, from a user, at least one on-line pseudo-identity to be associated with said user;
ensure that said on-line pseudo-identity is unique within a special interest group in which said user is a member;
generate an electronic credential for said user, wherein said electronic credential includes said at least one on-line pseudo-identity to be associated with said user, and wherein said electronic credential further includes an identifier of said special interest group in which said user is a member;
electronically sign said electronic credential such that said electronic credential includes a digital signature;
make said electronic credential available to said user; and
make available to at least one on-line merchant at least one encryption key associated with said digital signature in said electronic credential.

21. A system for facilitating on-line transactions, comprising:
means for obtaining, from a user, at least one on-line pseudo-identity to be associated with said user;
means for ensuring that said on-line pseudo-identity is unique within a special interest group in which said user is a member;
means for generating an electronic credential for said user, wherein said electronic credential includes said at least one on-line pseudo-identity to be associated with said user, and wherein said electronic credential further includes an identifier of said special interest group in which said user is a member;
means for electronically signing said electronic credential such that said electronic credential includes a digital signature;
means for making said electronic credential available to said user; and
means for making available to at least one on-line merchant at least one encryption key associated with said digital signature in said electronic credential.
